(19) United States
(12) Patent Application Publication
(10) Pub. No.: US 2005/0087061 A1
(43) Pub. Date: Apr. 28, 2005

(54) Musical keyboard pitch functions

(76) Inventors: Wong Hoo Sim, Singapore (SG); Phoei Min Paul Seow, Singapore (SG); Kok Liang Lim, Singapore (SG)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/443,272

(22) Filed: May 21, 2003

(51) Int. Cl. G10H 1/32

(52) U.S. Cl. 84/719

(57) ABSTRACT

A method to alter the pitch of a portion of a music keyboard by a transposition, including: upon a prescribed function key being activated to provide the transposition function for the portion, and upon a music key of the music keyboard being activated; determining if the transposition function has been activated and, if the music key is in the portion and checking a lookup table and altering a note corresponding to the music key by the transposition. Also disclosed is a method for enabling a bending of at least one note produced by a musical keyboard such that, upon a bending function being activated and a range for the bending being selected and set, and upon at least one music key of the music keyboard being pressed by a user to cause the at least one note to be produced and the bending function being instructed, bending the at least one note in accordance with the selected and set range for the bending. Keyboards for performing the methods are also disclosed.

### FIELD OF THE INVENTION

The present invention relates to musical keyboard pitch functions and refers particularly, though not exclusively, to a musical keyboard whereby a user of a musical keyboard, such as a MIDI keyboard, has greater control over pitch function.

### DEFINITIONS

Throughout this specification reference to “alphanumeric” is to be taken as including any symbols that may be found on the keys of a computer keyboard including regional or national alphabets, scripts and symbols. For example, a so-called “western” keyboard may include the following alphanumeric keys:
alpha keys a to z;
numeric keys 0 to 9;
function keys including dedicated function keys such as, for example, F1 to F12, and such keys as Internet access keys;
instructional keys such as, for example, “Esc”, “Enter”, “Ctl”, “Shift”, “Tab”, “Caps Lock”, “Delete”, “Insert”, “Home”, “Page Up”, “Page Down”, “End”, “Num Lock”;
cursor control keys;
and the “Shift” function of all of them.

### BACKGROUND OF THE INVENTION

Music playing is limited to the number of keys available on a musical keyboard. No hardware or software is available to increase the number of keys as and when required by user.

With electronic musical keyboards such as, for example, an electric piano, electronic organ, or synthesizer, a pitch bend wheel may be provided so that a user can bend the sound of a single note by up to a fixed amount, usually a whole tone. Pitch Bend is the controlled alteration of the pitch of a note, or a combination of notes, from the original pitch to a predetermined pitch by the usage of a key (normally a wheel-shaped key) called the pitch bend wheel. It can have an upward or downward bend effect. Pitch bends have been available for some time but are limited to a maximum bend of a semitone up or a semitone down. This is fixed and cannot be changed by user input.

### SUMMARY OF THE INVENTION

According to one aspect of the present invention there is provided a method to alter a pitch of a portion of a music keyboard by a transposition, the method including:
(a) upon a prescribed function key being activated to provide the transposition function for the portion; and
(b) upon a music key of the musical keyboard;
(c) determining if the transposition function has been activated; and,
(d) if the music key is in the portion, and checking a lookup table and altering a note corresponding to the music key by the transposition.

The portion may be one octave, and the transposition may be one octave higher or lower. The portion may be a highest octave of the music keyboard, or may be a lowest octave of the music keyboard.

In another form, the invention provides a musical keyboard having an extended range function, the musical keyboard including activation means for activating a transposition function of at least a portion of the musical keyboard, the transposition function transposing the portion by an interval as a result of activation of the alteration function.

The portion may be one octave. The interval may be one octave higher, and the portion a highest octave of the music keyboard. Alternatively, the interval may be one octave lower and the portion a lowest octave of the music keyboard.

Another aspect of the invention provides a method for enabling a bending of at least one note produced by a music keyboard, the method including, upon a bending function being activated and a range for the bending being selected and set, and, upon at least one music key of the music keyboard being pressed by a user to cause the at least one note to be produced and bending being instructed, bending the at least one note in accordance with the selected and set range for the bending.

The range for the bending may be in the range of from one to twelve semitones. The bending may be up, down, up-then-down, or down-then-up.

A further aspect of the invention provides a music keyboard having a means to enable a bending of at least one note produced by a pressing of at least one music key of the music keyboard; the music keyboard including means for enabling the selecting and setting of at least one of a range for the bending and a scale for the bending, and wherein a lookup table is provided to enable the music keyboard to bend the at least one note in accordance with the selected and set at least one range of the bending and scale of the bending.

The range for the bending may be in the range of from one to twelve semitones. The bending may be up, down, up-then-down, and down-then-up.

The present invention provides a computer useable medium comprising a computer program code that is figured to cause a processor to execute one or more functions to perform a method to alter the pitch of a portion of a music keyboard by a transposition, the method including:
(a) upon a prescribed function key being activated to provide the transposition function for the portion;
(b) upon a music key of the musical keyboard being activated;
(c) determining if the transposition function has been activated; and
(d) if the music key is in the portion, checking a lookup table and altering a note corresponding to the music key by the transposition.

And a computer useable medium comprising a computer program code that is figured to cause a processor to execute one or more functions to perform a method to bend at least one note produced by a music keyboard, the method including the steps, upon a bending function being activated and a range for the bending being selected and set, and, upon at least one music key of the music keyboard being pressed by a user to cause the at least one note to be produced and bending being instructed, bending the at least one note in accordance with the selected and set range for the bending.

### DESCRIPTION OF THE DRAWINGS

In order that the invention may be fully understood and readily put into practical effect, there shall now be described by way of non-limitative example only preferred embodiments of the present invention, the description being with reference to the accompanying illustrative drawings in which:

FIG. 1 is a perspective view of a system using a keyboard according to the present invention;

FIG. 2 is a perspective view of a keyboard according to the present invention;

FIG. 3 is a flow chart of a first embodiment; and

FIG. 4 is a flow chart of a second embodiment.

### DESCRIPTION OF PREFERRED EMBODIMENTS

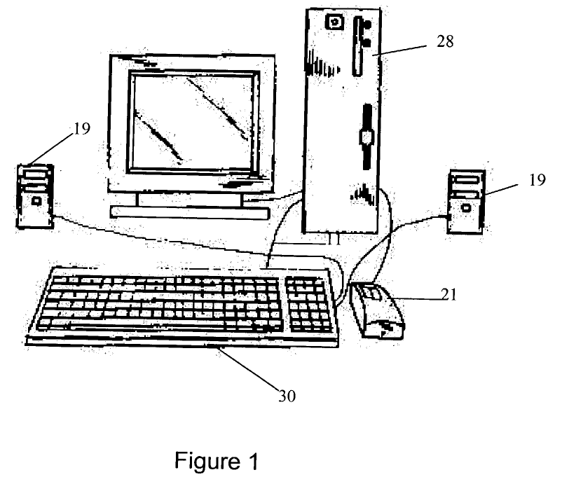

In FIG. 1 there is shown a host computer 28 having a keyboard 30. Keyboard 30 may be connected to host 28 by a cable 11 or by any suitable wireless system using radio frequency or infrared transmission. Speakers 19 are connected to host 28 in any suitable manner. Other peripherals (e.g. mouse 21, printers) may be provided and be connected to host 28.

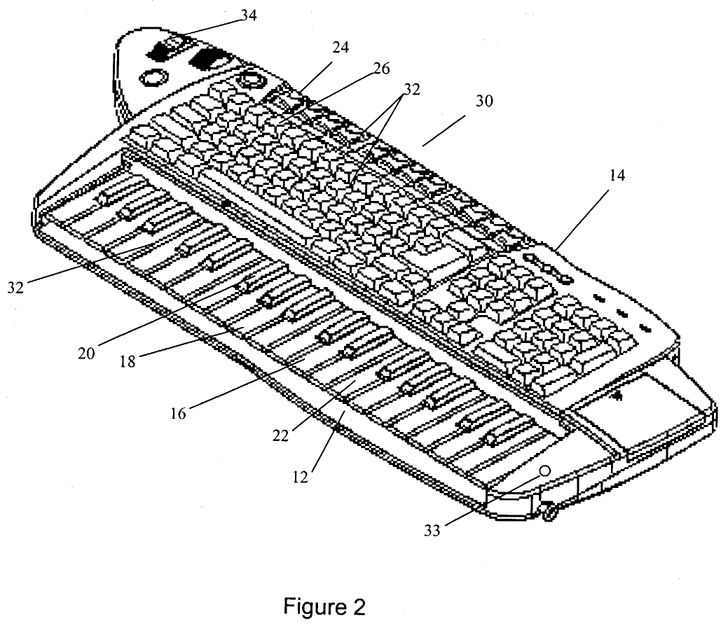

To now refer to FIG. 2, there is shown the keyboard 30. It is preferably a combined keyboard as described and defined in our earlier application PCT/SG01/00040 (“our earlier application”) the contents of which are hereby incorporated by reference. Although the present invention is applicable to the combined alphanumeric and musical keyboard 30 as illustrated in our earlier application, it can be used with a musical keyboard for any electronic musical instrument such as, for example, an electronic organ, electric piano, or synthesizer. The combined keyboard 30 has a musical keyboard 12 and an alphanumeric keyboard 14. The musical keyboard 12 may be a MIDI keyboard, or may operate in a quasi MIDI mode. It may also be according to any other relevant system or standard for musical keyboards of electronic musical instruments. The musical keyboard 12 includes a plurality of musical keys 16 including “white” keys 18 and “black” keys 20. The number of keys 16 may be as desired such as, for example, 37, 49, 61 or 88.

Pitch shifting is the shifting of the pitch of all MIDI keys by a pre-selected number of semitones. Once set, it will apply to the entire range of MIDI keys. In the case of the present invention, by pressing a combination of an alphanumeric function key plus a MIDI key the alphanumeric key tells a driver to prepare to receive an input, and the pressed MIDI keys tells the driver by what increment to shift all the MIDI keys up or down.

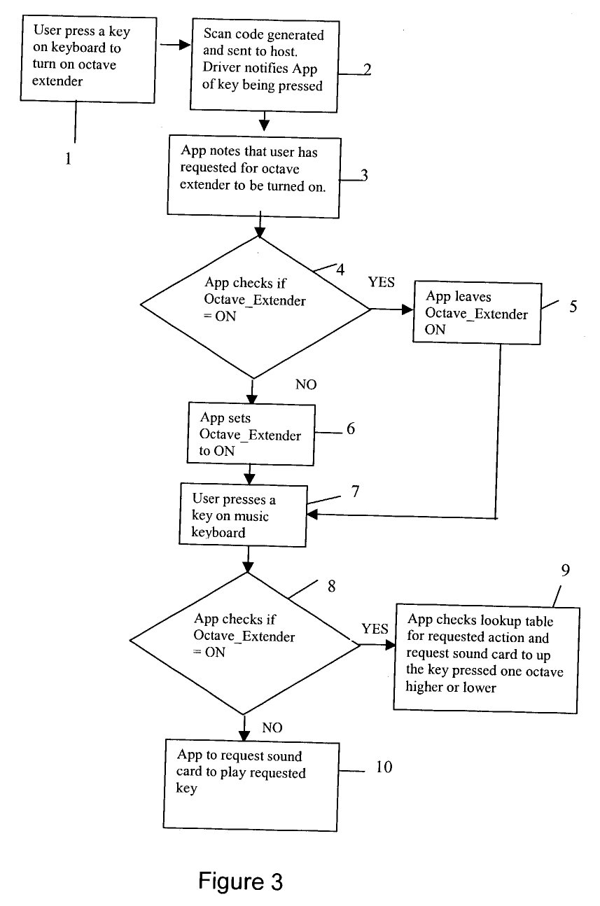

In FIG. 3, there is shown the process for extending the final octave 22 of the musical keyboard 12. The final octave 22 contains the 13 keys of an octave. In step 1, a user activates a function key to activate the octave extender function. That function key may be a function key 24 of the musical keyboard 12, on an integrated or separate keypad, may be a key 26 of the alphanumeric keyboard 14 associated with the musical keyboard 12, or may be a separate ON/OFF switch 33 on the keyboard 12. By associated it means the alphanumeric keyboard 14 is integrated with the musical keyboard 12 as shown in our earlier application, or which is sufficiently nearby for both keyboards 12,14 to be able to be used simultaneously by a user.

To refer to FIG. 3, upon the function key 24, 26 being activated, a scan code is generated and sent to the host 28. The host 28 may be built-in to the musical keyboard 12, or may be a computer associated with the keyboard 10. The host computer 28 may be a PC, laptop, a dedicated sound-processing device, or the like. A driver in the host notifies the application of the function key 24,26 being pressed (step 2). The application notes this (3), and that the user has requested the octave extender to be activated. The application (4) checks if the octave extender is presently ON or OFF. If ON (5), the application leaves the octave extender ON. If OFF (6), the application sets the octave extender to ON. When the user requests the octave extender to be deactivated, the application (4) checks if the octave extender is presently ON or OFF. If OFF (5), the application leaves the octave extender OFF. If ON (6), the application sets the octave extender to OFF.

The user (7) then presses one of the music keys 16 on the music keyboard 12. The application (8) checks if octave extender is ON and if the music key is in the range covered by the octave extension function, for example, the final octave 22 of the music keyboard 12. If YES to both, in (9) the application checks a lookup table for the requested action and requests a sound generator such as, for example, a sound card in host 28 to produce the music sound relevant for the music key, but for the note to be transposed in accordance with the functionality initially requested. The functionality may be for the highest octave 22 of the music keyboard 12 to be transposed up an octave; or for the lowest octave 31 of the music keyboard 12 to be transposed down an octave. The transposition may be for more or less than an octave and may be pre-set or may be set by user input. The portion of the music keyboard transposed may be the highest octave 22 and/or the lowest octave 31, and may be preset or set by user input. It may be more or less that one octave of the relevant portion of the musical keyboard and, again, the portion and extent of the musical keyboard being transposed may be pre-set or may be set by user input.

If, however, the application determines that octave extender is not activated (10) the application instructs the sound generator to play the musical sound requested upon the music key being pressed.

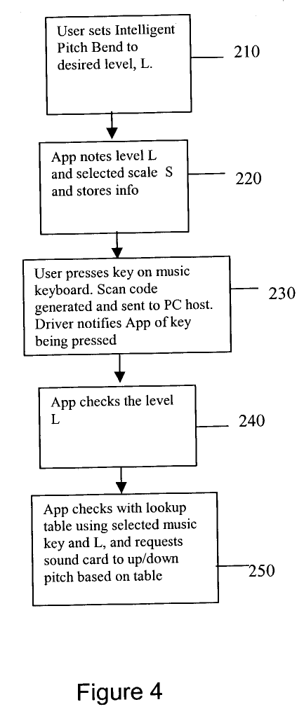

To now refer to FIG. 4, again the user activates a function key 32 to enable the user to select and set the pitch bend control to required level, L. The level is the number of semi-tones through which the pitch can be bent. This may be able to be separately varied for up bend and down bend. The level setting of the level L may be by hardware (e.g. rheostat) and/or software.

If desired there may be an additional function whereby the user can also select and set the relevant scale, S, so that the pitch bend will be musically correct. For example, if playing in the key of D, the pitch bend will automatically play the F as F#, and the C as C#. This may be relevant if the musical keyboard is for an organ or piano, or is an electronic version of an organ or piano.

The application notes the level L (220) and stores the information. The user then presses one of the musical keys 16 on the musical keyboard 12 such that a scan code is generated and sent to the host 28. The host 28 may be built-in to the musical keyboard, or may be separate. If separate, it may be a computer such as a PC or laptop. The driver in the host 28 notifies the application of the music key 16 being pressed. The application instructs a sound generator such as, for example, a sound card in the host 28 to produce the music sound corresponding to the key being pressed.

Upon the user also operating the pitch bend function by turning the usual knob 34, the application checks the level, L, that has been selected and set by the user (240). The application then checks (250) a lookup table using L and, from the result of the check, instructs the sound card to vary (or “bend”) the note being played by level L. The variation may be up or down, up then down, or down then up. Upon the pitch bend knob 34 being released, the music sound returns to normal. The movement between the two notes is in the form of a fast glissando, effectively covering all musical frequencies between the start note and the end note, with the speed of movement being determined by the speed of operation of the pitch bend wheel. The level, L, may be any number of semitones such as, for example, in the range from one to twelve semitones.

The present invention also extends to a computer useable medium comprising a computer program code that is configured to cause a processor to execute one or more of the functions and steps described above; and to a musical keyboard (with host) so programmed.

Whilst there has been described in the foregoing description preferred embodiments of the present invention, it will be understood by those skilled in the technology that many variations or modifications in the process steps and system may take place without departing from the present invention.

1. A method to alter the pitch of a portion of a music keyboard by a transposition, the method including:
a. upon a prescribed function key being activated to provide the transposition function for the portion; and
b. upon a music key of the musical keyboard being activated; performing the steps:
c. determining if the transposition function has been activated; and,
d. if the music key is in the range of the portion, checking a lookup table and altering a note corresponding to the music key by the transposition.

2. A method as claimed in claim 1, wherein the portion is one octave.

3. A method as claimed in claim 1, wherein the transposition is one octave higher.

4. A method as claimed in claim 1, wherein the transposition is one octave lower.

5. A method as claimed in claim 2, wherein the portion is a highest octave of the music keyboard.

6. A method as claimed in claim 2, wherein the portion is a lowest octave of the music keyboard.

7. A method as claimed in claim 1, wherein the transposition is one octave higher and the portion is a highest octave of the music keyboard.

8. A method is claimed in claim 1, wherein the transposition is one octave lower and the portion is a lowest octave of the music keyboard.

9. A musical keyboard including:
(a) a first plurality of musical keys;
(b) a transposition function for transposing the pitch of portion of the musical keyboard upon activation of the transposition function, the portion containing a second plurality of musical keys, the second plurality being less than the first plurality.

10. A musical keyboard as claimed in claim 9 wherein the portion is one octave.

11. A musical keyboard as claimed in claim 10, wherein the transposition is one octave higher and the portion is a highest octave of the music keyboard.

12. A musical keyboard as claimed in claim 10, wherein the transposition is one octave lower and the portion is a lowest octave of the music keyboard.

13. A method for enabling a bending of at least one note produced by a music keyboard, the method including:
a. upon a bending function being activated and a range for the bending being selected and set; and
b. upon at least one music key of the music keyboard being pressed by a user to cause the at least one note to be produced and the bending function being instructed, bending the at least one note in accordance with the selected and set range for the bending.

14. A method as claimed in claim 13, wherein the range for the bending is in the range of from one to twelve semitones.

15. A method as claimed in claim 13, wherein the bending is selected from the group consisting of: up, down, up-then-down, and down-then-up.

16. A music keyboard having a means to enable a bending of at least one note produced by a pressing of at least one music key of the music keyboard; the music keyboard including means for enabling the selecting and setting of at least one of a range for the bending, and wherein a lookup table is provided to enable the music keyboard to bend the at least one note in accordance with the selected and set range of the bending.

17. A music keyboard as claimed in claim 16, wherein the range for the bending is in the range of from one to twelve semitones.

18. A music keyboard as claimed in claim 16, wherein the bending is selected from the group consisting of: up, down, up-then-down, and down-then-up.

19. A computer useable medium comprising a computer program code that is figured to cause a processor to execute one or more functions to perform a method to alter the pitch of a portion of a music keyboard by a transposition, the method including:
a. upon a prescribed function key being activated to provide the transposition function for the portion; and
b. upon a music key of the musical keyboard being activated; performing the step:
c. determining the transposition function has been activated; and,
d. if the music key is in the portion, checking a lookup table and altering a note corresponding to the music key by the transposition.

20. A computer useable medium comprising a computer program code that is configured to cause a processor to execute one or more functions to a method to bend at lest one note produced by a music keyboard, the method including:
a. upon a bending function being activated and a range for the bending being selected and set; and
b. upon at least one music key of the music keyboard being pressed by a user to cause the at least one note to be produced and the bending function being instructed, bending the at least one note in accordance with the selected and set range for the bending.
